(19) United States
(12) Patent Application Publication
(10) Pub. No.: US 2025/0011527 A1
(43) Pub. Date: Jan. 9, 2025

(54) MODIFIED NAPHTHOL RESIN AND PREPARATION METHOD THEREOF

(71) Applicant: NAN YA PLASTICS CORPORATION, TAIPEI (TW)

(72) Inventors: Te-Chao Liao, TAIPEI (TW); Chi-Lin Chen, TAIPEI (TW); Hung-Yi Chang, TAIPEI (TW)

(73) Assignee: NAN YA PLASTICS CORPORATION, TAIPEI (TW)

(21) Appl. No.: 18/459,456

(22) Filed: Sep. 1, 2023

(30) Foreign Application Priority Data
Jul. 7, 2023 (TW) 112125567

(51) Int. Cl. C08G 61/02

(52) U.S. Cl. CPC C08G 61/02; C08G 2261/143; C08G 2261/34; C08G 2261/592; C08G 2261/724

(57) ABSTRACT

A preparation method of a modified naphthol resin includes the following. A nitration reaction and a hydrogenation reaction are sequentially performed on a naphthol resin to form a modified naphthol resin with an amino group in a structure. A solvent used in the hydrogenation reaction includes tetrahydrofuran, toluene, isopropanol, an amide solvent, or an above-mentioned co-solvent.

### CROSS-REFERENCE TO RELATED APPLICATION

This application claims the priority benefit of Taiwan application serial no. 112125567, filed on Jul. 7, 2023. The entirety of the above-mentioned patent application is hereby incorporated by reference herein and made a part of this specification.

### BACKGROUND

### Technical Field

The disclosure relates to a resin and a preparation method thereof, and more particularly, to a modified naphthol resin and a preparation method thereof.

### Description of Related Art

In the field of electronic products or the manufacture thereof, there are often demands for resin materials such as insulating materials, adhesives, and film raw materials. Currently, an epoxy resin or a polyphenylene ether (PPE) resin is widely used. However, the epoxy resin or polyphenylene ether may not perform well in terms of dielectric properties or heat resistance, which may cause corresponding limitations in the application of electronic products.

### SUMMARY

The disclosure provides a modified naphthol resin and a preparation method thereof. The preparation method of the modified naphthol resin in the disclosure has a higher hydrogenation rate.

A preparation method of a modified naphthol resin in the disclosure includes the following. A nitration reaction and a hydrogenation reaction are sequentially performed on a naphthol resin to form a modified naphthol resin with an amino group in a structure. A solvent used in the hydrogenation reaction includes tetrahydrofuran, toluene, isopropanol, an amide solvent, or an above-mentioned co-solvent.

A modified naphthol resin in the disclosure includes the above preparation method of the modified naphthol resin. The modified naphthol resin has a structure represented by a following [Formula 4].

Based on the above, since the solvent used in the hydrogenation reaction includes tetrahydrofuran, toluene, isopropanol, the amide solvent, or the above-mentioned co-solvent, the preparation method of the modified naphthol resin may have a higher hydrogenation rate.

### BRIEF DESCRIPTION OF THE DRAWINGS

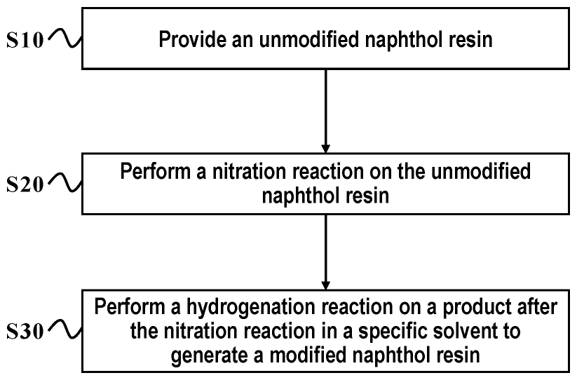

The FIG. 1s a schematic flow chart of a preparation method of a modified naphthol resin according to an embodiment of the disclosure.

### DETAILED DESCRIPTION OF DISCLOSED EMBODIMENTS

In the following detailed description, for purposes of explanation and not limitation, exemplary embodiments disclosing specific details are set forth in order to provide a thorough understanding of the various principles of the disclosure. It will be apparent, however, to one of ordinary skill in the art, having been benefited from this disclosure, that the present disclosure may be practiced in other embodiments that depart from the specific details disclosed herein. Furthermore, descriptions of commonly-known devices, methods, and materials may be omitted so as not to shift the focus from the description of the various principles of the present disclosure.

Ranges may be expressed herein as “about” one particular value to “about” another particular value, which can also be expressed directly as one particular value and/or to another particular value. When expressing the range, another embodiment includes the one particular value and/or to the other particular value. Similarly, when values are expressed as approximations, by use of the antecedent “about,” it will be understood that the particular value forms another embodiment. It will be further understood that an endpoint of each range is clearly related or unrelated to the other endpoint.

In this document, non-limiting terms (such as: may, can, for example, or other similar terms) are non-essential or optional implementation, inclusion, addition or presence.

Unless otherwise defined, all terms (including technical and scientific terms) used herein have the same meaning as commonly understood by one of ordinary skill in the art to which this disclosure belongs. It will also be understood that terms (such as those defined in commonly used dictionaries) should be interpreted to have meanings consistent with those in the relevant technical context and should not be interpreted in an idealized or overly formal sense, unless explicitly defined as such.

Referring to the FIGURE, a preparation method of a modified naphthol resin may include the following steps. In step S10, an unmodified naphthol resin is provided. In step S20, a nitration reaction is performed on the unmodified naphthol resin. In step S30, a hydrogenation reaction is performed on a product after the nitration reaction in a specific solvent to generate a modified naphthol resin.

### [Unmodified Naphthol Resin]

In an embodiment, the unmodified naphthol resin may be substituted with an alkyl group with only hydrogen or hydrogen of one to five carbons (which may be counted as C1 to C5) on a corresponding naphthol group

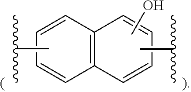

The naphthol group may include 1-naphthol group

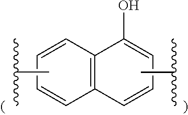

or 2-naphthol group

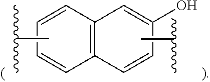

In an embodiment, the unmodified naphthol resin may not have any nitro, nitroso, or amino groups on the corresponding naphthol group. In an embodiment, the unmodified naphthol resin does not have any nitro, nitroso, or amino groups.

In an embodiment, a chemical formula of the unmodified naphthol resin may be represented by the following [Formula 1].

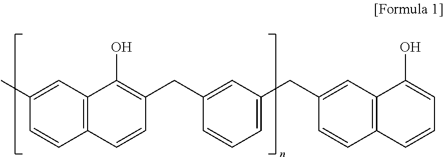

In [Formula 1], n may be a positive integer ranging from 2 to 40.

In an embodiment, the chemical formula of the unmodified naphthol resin may be similar to [Formula 1]. For example, a hydrogen atom connected to a carbon atom may be substituted with an alkyl group with one to five carbons (which may be counted as C1 to C5). For another example, hydroxyl in the naphthol group may be located at other substituent positions.

In an embodiment, a number-average molecular weight (Mn) or a weight-average molecular weight (Mw) of a polymer may be measured by a gel permeation chromatography (GPC).

In an embodiment, the number-average molecular weight or weight-average molecular weight is used for estimation, and an average value of n may be between 4 and 31.

In an embodiment, the unmodified naphthol resin may be commercially available (for example, a product name, ResiCare®4000, manufactured by Shanghai Hengfeng New Material Technology Co., Ltd.).

### <Nitration Reaction>

The nitration reaction may be performed on the unmodified naphthol resin by a nitrating agent.

In an embodiment, the nitration reaction may be performed in a common nitration reaction tank.

In an embodiment, the nitrating agent used in the nitration reaction is halo nitrobenzene.

In an embodiment, considering corresponding reactivity and/or steric effects of chemical reaction, the halo nitrobenzene in the nitration reaction is 4-halo nitrobenzene. For example, the nitration reaction may be performed by adding 4-halo nitrobenzene to a solution in which the unmodified naphthol resin has been dissolved.

A chemical formula of 4-halo nitrobenzene may be represented by the following [Formula 2].

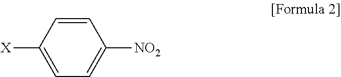

In [Formula 2], X may be fluoro, chloro, bromo, or iodo.

In an embodiment, considering reactivity of a reactant, preferably, X is fluorine (i.e., 4-fluoronitrobenzene).

In an embodiment, a ratio of a total mole number of hydroxyl in the unmodified naphthol resin to a mole number of 4-halo nitrobenzene may be 1:1 to 1:2.5; preferably, 1:1.01 to 1:1.05.

In an embodiment, the total mole number of hydroxyl in the unmodified naphthol resin may be estimated from a mole number of the reactant that generate hydroxyl in the unmodified naphthol resin.

In an embodiment, the total mole number of hydroxyl in the unmodified naphthol resin may be calibrated or estimated by commonly used standards (such as, including but not limited to, ISO 4629-2:2016, ASTM E222-10, GB/T 12008.3, CNS 6681).

In an embodiment, considering the corresponding reactivity, the nitration reaction is preferably performed in an alkaline environment.

In an embodiment, considering the corresponding reactivity and corresponding solubility of the unmodified naphthol resin, the solvent used in the nitration reaction may be a co-solvent including an amide solvent or be an amide solvent. The amide solvent may include, but is not limited to N-methylpyrrolidone (NMP), dimethylacetamide (DMAC), dimethylformamide (DMF), or tetramethylurea (TMU).

In an embodiment, a corresponding pH value may be adjusted by adding an alkali agent (such as sodium carbonate, potassium carbonate, or the like).

In an embodiment, a mole number of a corresponding hydroxyl ion in the alkali agent is about 1 to 2 times the total mole number of hydroxyl of the unmodified naphthol resin.

In an embodiment, the solvent for the nitration reaction may be, for example, an amount of 5 mol to 7 mol of potassium carbonate dissolved in 6 mol of dimethylacetamide or a dimethylacetamide solution with the same alkali equivalent.

After the nitration reaction is performed on the unmodified naphthol resin of [Formula 1] and halo nitrobenzene of [Formula 2], a naphthol resin having a nitro structure as shown in the following [Formula 3] may be generated.

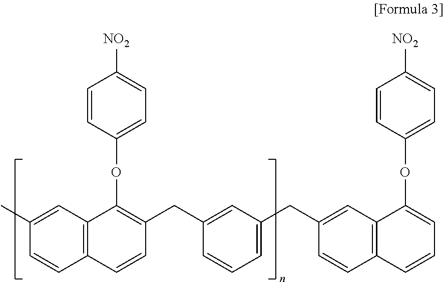

A definition of n in [Formula 3] is basically the same as a definition of n in [Formula 1] corresponding thereto. A reason for “the definitions of n are basically the same” is that in a chemical reaction, there may be unintentional but unpredictable and/or unavoidable side reactions.

### <Hydrogenation Reaction>

After the hydrogenation reaction is performed on a naphthalene resin having the nitro structure of [Formula 3], a modified naphthol resin may be generated as shown in following [Formula 4].

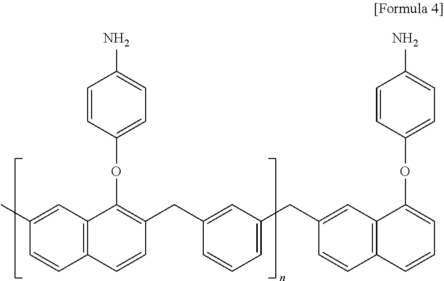

A definition of n in [Formula 4] is basically the same as the definitions of n in the corresponding [Formula 1] and/or [Formula 3].

In an embodiment, the hydrogenation reaction may be performed in a common hydrogenation reaction tank. For example, a guided gas stirrer is disposed in the hydrogenation reaction tank. In addition, after a reaction solution is placed in the hydrogenation reaction tank, hydrogen gas may be input into the hydrogenation reaction tank to perform the hydrogenation reaction. An amount and/or a flow rate of the hydrogen gas may be adjusted according to a set gas pressure (about 5 bar to about 100 bar).

In an embodiment, a temperature of the hydrogenation reaction does not substantially exceed a boiling point or a azeotropic point of the solvent used.

In an embodiment, the hydrogenation reaction is performed in a solvent at a temperature of about 50° C. to 120° C., preferably, about 80° C. to 110° C.

In an embodiment, the hydrogenation reaction may be performed in tetrahydrofuran (THF), toluene, isopropanol (IPA), the amide solvent (such as dimethylacetamide (DMAC)), or in an above co-solvent. The solvent used in the hydrogenation reaction may have a direct impact on a hydrogenation rate and/or the side reactions.

In an embodiment, the solvent for the hydrogenation reaction may be a co-solvent of toluene and isopropanol. A volume ratio of toluene to isopropanol may be about 80:20 to 100:0, preferably, about 80:20 to 75:25.

In an embodiment, the solvent for the hydrogenation reaction may be a co-solvent formed by dimethylacetamide and toluene or dimethylacetamide. A volume ratio of dimethylacetamide to toluene may be about 75:25 to 100:0, preferably, about 90:10 to 100:0

In an embodiment, considering the previously performed nitration reaction, the solvent used in the hydrogenation reaction may be similar to the solvent used in the previously performed nitration reaction. In an embodiment, the solvent used in the hydrogenation reaction may be the co-solvent including the amide solvent or the amide solvent.

In an embodiment, the solvent used in the hydrogenation reaction is only the amide solvent, and does not include other non-amide solvents. In an embodiment, if the solvent used in the hydrogenation reaction is only the amide solvent, it may be possible to have a higher hydrogenation rate.

In an embodiment, pressure of reaction gas (such as the hydrogen gas) in the hydrogenation reaction may be reacted at a pressure of about 5 bar to about 100 bar, preferably, may be reacted at a pressure of about 15 bar to about 30 bar.

In an embodiment, the reaction time of the hydrogenation reaction is about 4 hours to 12 hours, preferably, about 8 hours to 12 hours.

In an embodiment, the hydrogenation reaction may be performed at the pressure of about 5 bar to 100 bar for about 4 hours to 12 hours, preferably, may be performed at the pressure of about 15 bar to 30 bar, preferably, may be performed for about 8 hours to 12 hours, and more preferably, the hydrogenation reaction may be performed at a pressure of about 5 bar to 30 bar for about 8 hours to 12 hours.

In an embodiment, the hydrogenation reaction may be appropriately heated under a corresponding pressure atmosphere.

In an embodiment, the hydrogenation reaction may include use of a suitable catalyst. For example, the reaction solution and a hydrogenation catalyst may be placed in the hydrogenation reaction tank to be mixed. In addition, after the reaction solution is placed in the hydrogenation reaction tank, the hydrogen gas may be input into the hydrogenation reaction tank to perform the hydrogenation reaction. After the hydrogenation reaction, the hydrogenation catalyst may be removed by filtration.

In an embodiment, the hydrogenation catalyst may be used to facilitate the hydrogenation reaction of a terminal nitro group. The hydrogenation catalyst may be a ruthenium (Ru) catalyst, a palladium (Pd) catalyst, a rhodium (Rh) catalyst, a platinum (Pt) catalyst, a nickel (Ni) catalyst, or a combination of the above.

In an embodiment, the hydrogenation catalyst is, for example, a metal with a porous structure, a metal alloy, or a solid heterogeneous catalysis including metal. For example, it may include but not limited to ruthenium-metal oxide (such as ruthenium-magnesium oxide (Ru—MgO) or ruthenium-titanium dioxide (Ru—TiO₂)), palladium carbon or similar palladium on carbon (Pd/C), platinum black, raney nickel, or a porous alumina (such as γ-Al₂O₃) support including platinum, rhodium, and/or palladium.

In an embodiment, based on a total usage of the reactant as 100 parts by weight, a usage of the hydrogenation catalyst is about 0.5 to 2 parts by weight, preferably, about 1.0 to 1.4 parts by weight, and more preferably, about 1.2 parts by weight (i.e., 1.2±10% wt %).

In an embodiment, by the above method, the hydrogenation rate of the hydrogenation reaction may be about 90% or more, preferably, may be about 94% or more, and more preferably, may be about 98% or more.

In an embodiment, the hydrogenation rate may be estimated by characteristic spectrum comparison. For example, the hydrogenation rate may be estimated by a decrease and/or an increase of a corresponding infrared characteristic spectrum of the terminal nitro group and/or a terminal amino group.

In an embodiment, the hydrogenation reaction may include the following reaction condition. The solvent is the co-solvent of toluene and isopropanol. The volume ratio of toluene to isopropanol is about 80:20 to 75:25. Based on the total usage of the reactant as 100 parts by weight, the usage of the hydrogenation catalyst is 1.2 parts by weight (i.e., 1.2±10% wt %, 1.08 wt % to 1.32 wt %), the reaction pressure is about 5 bar (i.e., 5±10% bar, 4.5 bar to 5.5 bar), the reaction temperature is about 110° C. (i.e., 110±10° C., 100° C. to 120° C.); and the reaction time is about 5 hours (i.e., 5±0.5 hours, 4.5 hours to 5.5 hours). In addition, the hydrogenation rate corresponding to the above reaction condition may be about 94%. In addition, a polymer dispersity index (PDI) corresponding to the above reaction condition is about 3.03.

In an embodiment, the hydrogenation reaction may include the following reaction condition. The solvent is the amide solvent and other non-amide solvents (such as dimethylacetamide and toluene). Based on the total usage of the reactant as 100 parts by weight, the usage of the hydrogenation catalyst is about 1.2 parts by weight (i.e., 1.2±10% wt %, 1.08 wt % to 1.32 wt %), the reaction pressure is about 20 bar (i.e., 20±10% bar, 18 bar to 22 bar), the reaction temperature is about 90° C. (i.e., 90±10° C., 80° C. to 100° C.), and the reaction time is about 10 hours (i.e., 5±0.5 hours, 4.5 hours to 5.5 hours). In addition, the hydrogenation rate corresponding to the above reaction condition may be about 98% or more. In addition, the polymer dispersity index corresponding to the above reaction condition is about 1.63, which may be due to the use of the amide solvent to reduce the possibility of the side reactions.

In an embodiment, the hydrogenation reaction may include the following reaction condition. The solvent is only the amide solvent (such as dimethylacetamide). Based on the total usage of the reactant as 100 parts by weight, the usage of the hydrogenation catalyst is about 1.2 parts by weight (i.e., 1.2±10% wt %, 1.08 wt % to 1.32 wt %), the reaction pressure is about 20 bar (i.e., 20±10% bar, 18 bar to 22 bar), the reaction temperature is about 90° C. (i.e., 90±10° C., 80° C. to 100° C.), and the reaction time is about 10 hours (i.e., 5±0.5 hours, 4.5 hours to 5.5 hours). In addition, the hydrogenation rate corresponding to the above reaction condition may be about 99% or more. In addition, the polymer dispersity index corresponding to the above reaction condition is about 1.53, which may be due to the use of only the amide solvent to reduce the possibility of the side reactions.

### <Application of Modified Naphthol Resin>

Since the modified naphthol resin represented by [Formula 4] may have better quality (e.g., relatively uniform in functional groups, morphologies, and/or structures), it may be suitable for applications in electronic products.

For example, the modified naphthol resin represented by [Formula 4] may be suitable for synthesis of a maleimide resin, a benzoxazine resin, and/or a polyimide resin (PI Resin). The corresponding maleimide resin, benzoxazine resin, and/or polyimide resin may be suitable for the manufacture of the electronic products (e.g., a copper clad laminate (CCL) for manufacturing a circuit board).

In an embodiment, in the application of the modified naphthol resin represented by [Formula 4] to the electronic products, since the modified naphthol resin used has better quality, the electronic products may also have better quality or better yield.

### <Preparation Example of Modified Naphthol Resin>

A commercially available unmodified naphthol resin containing hydroxyl of 1 mole (the product name ResiCare®4000, manufactured by Shanghai Hengfeng New Material Technology Co., Ltd. with Prior Company Limited as an agent, which includes the unmodified naphthol resin represented by [Formula 1]) was added to dimethylacetamide (DMAC) of about 6 moles to be dissolved. Next, potassium carbonate of about 1.25 moles and 4-fluoronitrobenzene of about 1.25 moles were added, reacted at a temperature of about 120° C. for about 5 hours, and then cooled to a room temperature. Then, filtration was performed to remove solids, and precipitation was performed with a mixed solution of methanol and water, so as to obtain a precipitate of a nitrated naphthol resin (e.g., [Formula 3]). Next, the precipitate was added to a mixed solvent (the volume ratio of about 80:20) formed by toluene and isopropanol, and palladium on carbon of about 1.2 parts by weight (based on the precipitate as 100 parts by weight) was added, so as to react at a temperature of about 110° C. and a pressure of about 5 bar for about 8 hours to perform the hydrogenation reaction and obtain the modified naphthol resin of Example 1 (such as [Formula 4]). The prepared modified naphthol resins were evaluated by each of the following evaluation methods, and results are shown in [Table 1].

The modified naphthol resins of Example 2 to Example 3 was prepared with the steps the same as or similar to Example 1, and a difference is that the solvent, reaction time, reaction temperature, and/or reaction pressure used in the hydrogenation reaction (as shown in [Table 1]) were changed. The prepared modified naphthol resins were evaluated by each of the following evaluation methods, and the results are shown in [Table 1].

TABLE 1

| | Item | Example 1 | Example 2 | Example 3 |
|---|---|---|---|---|
| Hydrogenation | Solvent | Toluene:Isopropanol = | Dimethylacetamide:Toluene = | Dimethylacetamide |
| condition | | 80:20 | 80:20 | |
| | | (volume | (volume | |
| | | ratio) | ratio) | |
| | Catalyst | 1.2 | 1.2 | 1.2 |
| | usage | | | |
| | (parts by | | | |
| | weight) | | | |
| | Reaction | 8 | 10 | 10 |
| | time | | | |
| | (hours) | | | |
| | Reaction | 110 | 90 | 90 |
| | temperature | | | |
| | (° C.) | | | |
| | Reaction | 5 | 20 | 20 |
| | pressure | | | |
| | (bar) | | | |
| Hydrogenation rate (%) | | 94 | 98 | 99 |
| Evaluation | Mn (g/mol) | 2457 | 1245 | 989 |
| result | Mw | 7444 | 2029 | 1483 |
| | (g/mol) | | | |
| | PDI | 3.03 | 1.63 | 1.50 |
| | Solubility | 50 | 50 | 50 |
| | in toluene | | | |
| | (%) | | | |
| | Solubility | 50 | 50 | 50 |
| | in butanone | | | |
| | (%) | | | |

### <Evaluation Method>

Number average molecular weight (Mn): The prepared modified naphthol resin was dissolved in tetrahydrofuran (THF) to prepare a solution to be tested with a concentration of 1% by weight. Next, a number average molecular weight of the solution to be tested was measured by the gel permeation chromatography (GPC).

Weight average molecular weight (Mw): The prepared modified naphthol resin was dissolved in tetrahydrofuran (THF) to prepare the solution to be tested with the concentration of 1% by weight. Next, a weight average molecular weight of the solution to be tested was measured by the gel permeation chromatography (GPC).

Polydispersity index (PDI): The measured weight average molecular weight is divided by the number average molecular weight (i.e., Mw/Mn) to obtain a polydispersity index (PDI). When the PDI is smaller, distribution of the molecular weight is shown to be more concentrated. Under the same or similar conditions of initial reactants, catalysts and corresponding amounts thereof, the smaller the PDI, the smaller the possibility of the corresponding side reactions, and the more concentrated the distribution of the molecular weight. Therefore, if the distribution of the molecular weight is more concentrated (i.e., the PDI is smaller), it may be said that the functional groups, morphologies, and/or structures are more uniform, and it may be called a more uniform reaction/synthesis. In addition, if the distribution of the molecular weight is more concentrated (i.e., the PDI is smaller), a proportion of products of the side reactions (such as larger polymer molecules formed by repolymerization) may also be smaller correspondingly. Therefore, in terms of product application, it may be more stable for subsequent processing or application, so that the subsequent processed products may have better quality or better yield.

Solubility in toluene: After the prepared modified naphthol resin of 1 g was placed in a container, toluene was added to make a solution with a weight of 2 g. The solution was left to stand for about 30 minutes after being shaken at a room temperature. After it was a clear solution, solubility thereof was measured.

Solubility in butanone: After the prepared modified naphthol resin of 1 g was placed in the container, butanone was added to make the solution with the weight of 2 g. After it was a clear solution, solubility thereof was measured.

Dielectric constant (Dk): The prepared modified naphthol resin was coated on a substrate, baked at 120° C. for 2 minutes, and then hot-pressed at 210° C. for 3 hours to form a film with a thickness of 100 μm. Then, a dielectric constant (Dk) at a frequency of 10 GHz was measured by a dielectric analyzer (a model of E4991A, manufactured by Agilent Technologies, Inc.). When the dielectric constant is smaller, it shows that the modified naphthol resin has good dielectric properties.

Dielectric factor (Df): The prepared modified naphthol resin was coated on the substrate, baked at 120° C. for 2 minutes, and then hot-pressed at 210° C. for 3 hours to form the film with the thickness of 100 μm. Then, a dielectric factor (Df) at the frequency of 10 GHz was measured by the dielectric analyzer (the model of E4991A, manufactured by Agilent Technologies, Inc.). When the dielectric factor is smaller, it shows that the modified naphthol resin has good dielectric properties.

Glass transition temperature (Tg): A glass transition temperature (Tg) of the prepared modified naphthol resin was measured by a dynamic mechanical analyzer (DMA). When the Tg is higher, it shows that the modified naphthol resin has good resistance to phase change, that is, good heat resistance. A temperature rise rate during the measurement is 10° C./min. A temperature range during the measurement is 30° C. to 300° C. (heating, cooling, and heating).

Peel strength: The prepared modified naphthol resin was coated on the substrate, and baked at a temperature of 120° C. for 2 minutes to form a resin film. Then, copper foil was laminated on upper and lower surfaces of the resin film, and hot pressing was performed at a temperature of 210° C. for 3 hours to form a film having a thickness of 200 μm. Next, the peel strength was measured by a universal tensile machine. When the peel strength is greater, it shows that the modified naphthol resin has a good ability to resist peeling from the substrate, that is, good peeling resistance.

### <Evaluation Result>

According to [Table 1], the preparation method of the modified naphthol resin includes the following. The nitration reaction and the hydrogenation reaction are sequentially performed on the unmodified naphthol resin to form the modified naphthol resin having an aminobenzene group in the structure. Moreover, the hydrogenation reaction is performed at least in the specific solvent, which may have a better hydrogenation rate. In addition, the prepared modified naphthol resin may also have better distribution of the molecular weight.

In addition, compared to the modified naphthol resin (Example 1) prepared by using the mixed solvent formed by toluene and isopropanol as the solvent for hydrogenation reaction, the modified naphthol resin (Example 2 or Example 3) prepared by using the solvent including dimethylacetamide as the solvent for hydrogenation reaction has a higher hydrogenation rate and a smaller polydispersity index (i.e., a more uniform distribution of the molecular weight).

In addition, compared to the modified naphthol resin (Example 1 or Example 2) prepared by using the mixed solvent as the solvent for the hydrogenation reaction, the modified naphthol resin (Example 3) prepared by using only the amide solvent (such as dimethylacetamide) as the solvent for the hydrogenation reaction has a higher hydrogenation rate and a smaller polydispersity index (i.e., the more uniform distribution of the molecular weight).

In addition, compared to the modified naphthol resin (Example 1) prepared by the hydrogenation reaction at a temperature greater than 90° C. and a pressure less than 15 bar, the modified naphthol resin (Example 2 or Example 3) prepared by the hydrogenation reaction at a temperature of 50° C. to 90° C. and a pressure of 15 bar to 50 bar has a higher hydrogenation rate and a smaller polydispersity index (i.e., the more uniform distribution of the molecular weight).

Based on the above, the preparation method of the modified naphthol resin in the disclosure may have a higher hydrogenation rate. In addition, the modified naphthol resin may have good distribution uniformity of the molecular weight and is suitable as a firming agent or suitable for forming a naphthol resin with other reactive groups, and has good applicability.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A preparation method of a modified naphthol resin, comprising:
sequentially performing a nitration reaction and a hydrogenation reaction on a naphthol resin to form a modified naphthol resin with an amino group in a structure,
wherein a solvent used in the hydrogenation reaction comprises tetrahydrofuran, toluene, isopropanol, an amide solvent, or an above-mentioned co-solvent.

2. The preparation method of the modified naphthol resin according to claim 1, wherein the solvent used in the hydrogenation reaction comprises at least the amide solvent.

3. The preparation method of the modified naphthol resin according to claim 1, wherein the amide solvent comprises N-methylpyrrolidone, dimethylacetamide, dimethylformamide, tetramethylurea, or an above-mentioned co-solvent.

4. The preparation method of the modified naphthol resin according to claim 3, wherein the amide solvent comprises at least dimethylacetamide.

5. The preparation method of the modified naphthol resin according to claim 1, wherein the hydrogenation reaction is performed in a following environment:
a reaction gas pressure of 5 bar to 100 bar;
reaction time of 4 hours to 12 hours; and
a reaction temperature of 50° C. to 120° C.

6. The preparation method of the modified naphthol resin according to claim 1, wherein the hydrogenation reaction further comprises use of a hydrogenation catalyst, wherein, based on a total usage of a reactant as 100 parts by weight, a usage of the hydrogenation catalyst is 0.5 to 2 parts by weight.

7. The preparation method of the modified naphthol resin according to claim 1, wherein the nitration reaction is performed in an alkaline environment.

8. The preparation method of the modified naphthol resin according to claim 1, wherein a nitrating agent used in the nitration reaction is a halo nitrobenzene.

9. The preparation method of the modified naphthol resin according to claim 1, wherein the naphthol resin has a structure represented by a following [Formula 1]: 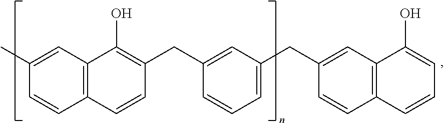
and
in the [Formula 1], n represents a positive integer of 2 to 40.

10. A modified naphthol resin, comprising the preparation method of the modified naphthol resin according to claim 1, and the modified naphthol resin has a structure represented by a following [Formula 4]: 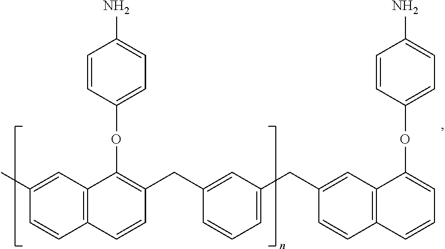
and
in the [Formula 4], n represents a positive integer of 2 to 40.
